(19) United States
(12) Patent Application Publication
(10) Pub. No.: US 2022/0140349 A1
(43) Pub. Date: May 5, 2022

(54) POSITIVE ELECTRODE FOR LITHIUM ION BATTERY AND LITHIUM ION BATTERY

(71) Applicant: HONDA MOTOR CO., LTD., Minato-ku, Tokyo (JP)

(72) Inventors: Kazuhiro Araki, Wako-shi (JP); Taku Matsuzaka, Wako-shi (JP)

(21) Appl. No.: 17/437,433

(22) PCT Filed: Mar. 12, 2019
(86) PCT No.: PCT/JP2019/010028

§ 371 Date: Sep. 9, 2021

(51) Int. Cl. H01M 4/66; H01M 4/131; H01M 4/58; H01M 4/525; H01M 10/0525

(52) U.S. Cl. CPC H01M 4/667; H01M 4/661; H01M 4/131; H01M 2004/028; H01M 4/525; H01M 10/0525; H01M 4/58

(57) ABSTRACT

Provided is a positive electrode for a lithium ion battery that realizes an increase in energy density and is capable of improving durability. A positive electrode for a lithium ion battery (21) has a positive electrode current collector (21A) and a positive electrode mixture layer (21B) formed on the positive electrode current collector (21A). The positive electrode mixture layer (21B) contains a lithium nickel composite oxide and a metallic phosphate that coats the lithium nickel composite oxide. The lithium nickel composite oxide is represented by a chemical formula LiNiₓCo_{y}M_{z}O₂ (in the formula, M is one or more elements selected from the group consisting of Mn, Al, Mg and W, x+y+z=1 and 0.6≤x<1.0). The metallic phosphate is one or more materials selected from the group consisting of VPO₄, VP₂O₇ and VPO₄F. The mass ratio of the metallic phosphate to the lithium nickel composite oxide is 0.01 mass % or more and 20 mass % or less.

### TECHNICAL FIELD

The present invention relates to a positive electrode for a lithium ion battery and a lithium ion battery.

### BACKGROUND ART

In recent years, along with the performance enhancement and multifunctionalization of electrical and electronic devices, there has been demand for an increase in energy density, an increase in capacity, an increase in output, improvement in durability, and the like in lithium ion batteries that supply power to a variety of devices. As one method for realizing such a demand, research is underway regarding positive electrode active materials which are a configuration member of positive electrodes.

As a conventional positive electrode active material, for example, a composite positive electrode active material containing a metallic phosphate and a lithium composite oxide has been proposed (Patent Literature 1).

The metallic phosphate is represented by a chemical formula (a): MₓP_{y}Oₓ (in the formula, M is one or more elements selected from vanadium (V), niobium (Nb) and tantalum (Ta), 1≤y/x≤1.33, and 4≤z/y≤5).

In addition, the lithium composite oxide is a compound represented by any of chemical formulae (b) to (e) below.

LiM₂O₄ Chemical formula (b):

(in the formula, M is one or more selected from the group consisting of nickel (Ni), manganese (Mn) and cobalt (Co))

Li₁₊ₓM₁₋ₓO₂ Chemical formula (c):

(in the formula, M is one or more selected from the group consisting of nickel (Ni), cobalt (Co), manganese (Mn), titanium (Ti), vanadium (V), iron (Fe), niobium (Nb) and molybdenum (Mo) and 0<x≤0.3)

LiₐNi_{b}Co_{c}Mn_{d}MₑO₂ Chemical formula (d):

(in the formula, M is one or more selected from the group consisting of titanium (Ti), vanadium (V), iron (Fe), niobium (Nb) and molybdenum (Mo), 1.1≤a<1.5, 0<b<1, 0≤c<1, 0<d<1, 0≤e<1 and 0<b+c+d+e<1)

Li₁₊ₓ₁M₁₋ₓ₁O₂ Chemical formula (e):

(in the formula, M is one or more selected from the group consisting of nickel (Ni), cobalt (Co), manganese (Mn), titanium (Ti), vanadium (V), iron (Fe), niobium (Nb) and molybdenum (Mo) and 0.1≤x1≤0.3)

In addition, as another conventional positive electrode active material, a positive electrode active material for a non-aqueous electrolyte secondary battery containing particles of a lithium nickel composite oxide represented by a chemical formula (f) below has been proposed (Patent Literature 2). In this positive electrode active material, a 1 to 200 nm-thick coating containing tungsten (W) and lithium (Li) is provided on the surfaces of the particles of the lithium nickel composite oxide, and, in the crystal of the lithium nickel composite oxide that is obtained by the Rietveld analysis of X-ray diffraction, the length of the c axis is 14.183 angstoms or longer and 14.205 angstroms or shorter.

Li_{b}Ni_{1-x-y}CoₓM_{y}O₂ Chemical formula (f):

(in the formula, M is at least one selected from magnesium (Mg), aluminum (Al), calcium (Ca), titanium (Ti), vanadium (V), chromium (Cr), manganese (Mn), niobium (Nb), zirconium (Zr) and molybdenum (Mo). b satisfies 0.95≤b≤1.03, x satisfies 0<x≤0.15, y satisfies 0<y≤0.07 and x+y satisfies x+y≤0.16)

Furthermore, as a configuration of another conventional positive electrode active material, a positive electrode active material containing particles of a lithium nickel composite oxide and particles of lithium vanadium phosphate that coat the particle surfaces of the lithium nickel composite oxide has been proposed (Patent Literature 3). In this positive electrode active material, the mass ratio between the lithium nickel composite oxide particles and the lithium vanadium phosphate particles is within a range of 5:85 to 60:30.

### CITATION LIST

### Patent Literature

### [Patent Literature 1]

Japanese Unexamined Patent Application, First Publication No. 2016-127024

### [Patent Literature 2]

PCT International Publication No. WO 2017-073246

### [Patent Literature 3]

Japanese Unexamined Patent Application, First Publication No. 2013/77420

### SUMMARY OF INVENTION

### Technical Problem

However, in Patent Literature 1, the composite positive electrode active material has a configuration in which, with an assumption that the lithium composite oxide is an overlithiated layered oxide (OLO) containing an excess of lithium, the OLO is coated with a predetermined metallic phosphate, and a certain degree of improvement in durability can be expected, but the open circuit voltage (OCV) decreases due to a change in the crystal structure of the positive electrode active material, and there is a problem in that the durability of lithium ion batteries deteriorates.

In Patent Literature 2, the positive electrode active material has a configuration in which the nickel fraction is increased in amount or the crystal structure in the lithium nickel composite oxide is controlled and the coating containing tungsten (W) and having a predetermined thickness is formed on the particles of the lithium nickel composite oxide, and the tungsten (W)-containing coating contributes to an increase in capacity, an increase in output and a decrease in resistance of lithium ion batteries, but is unlikely to contribute to improvement in durability.

In addition, in Patent Literature 3, the positive electrode active material has a configuration in which the mass ratio of the lithium vanadium phosphate particles to the lithium nickel composite oxide particles is set to 30 mass % or more and 85 mass % or less, whereby the surfaces of the lithium nickel composite oxide particles are barely exposed, and the oxidative decomposition of the lithium nickel composite oxide particles can be suppressed. However, since lithium vanadium phosphate also functions as a positive electrode active material, the discharge capacity of the lithium vanadium phosphate significantly affects the discharge capacity of the entire positive electrode active material, the discharge capacity decreases as a whole in the positive electrode active material, and a decrease in the energy density is caused.

An object of the present invention is to provide a positive electrode for a lithium ion battery and a lithium ion battery that realize an increase in energy density and are capable of improving durability.

### Solution to Problem

As a result of repeating intensive research, the present inventors found that, when a lithium nickel composite oxide having a nickel fraction increased up to a specific range is coated with a metallic phosphate and, furthermore, the mass ratio of the metallic phosphate to the lithium nickel composite oxide is set to a specific range, an increase in the energy density of a lithium ion battery is realized due to the high nickel fraction, and oxygen desorption from the surface of the lithium nickel composite oxide is sufficiently suppressed due to the metallic phosphate having a specific mass ratio that is lower than in the related art, which makes it difficult for an inactive nickel oxide to be generated on the surface of the lithium nickel composite oxide and thus makes it possible to improve the durability of lithium ion batteries.

That is, the gist configuration of the present invention is as follows.

[1] A positive electrode for a lithium ion battery having a positive electrode current collector and a positive electrode mixture layer formed on the positive electrode current collector,

in which the positive electrode mixture layer contains a lithium nickel composite oxide and a metallic phosphate that coats the lithium nickel composite oxide,

the lithium nickel composite oxide is represented by a chemical formula LiNiₓCo_{y}M_{z}O₂ (in the formula, M is one or more elements selected from the group consisting of Mn, Al, Mg and W, x+y+z=1 and 0.6≤x<1.0), the metallic phosphate is one or more materials selected from the group consisting of VPO₄, VP₂O₇ and VPO₄F, and

a mass ratio of the metallic phosphate to the lithium nickel composite oxide is 0.01 mass % or more and 20 mass % or less.

[2] The positive electrode for a lithium ion battery according to [1], in which, in the chemical formula, 0<y≤0.2 is satisfied.

[3] The positive electrode for a lithium ion battery according to [1], in which the metallic phosphate coats an entire surface of the lithium nickel composite oxide.

[4] The positive electrode for a lithium ion battery according to [1], in which the mass ratio of the metallic phosphate to the lithium nickel composite oxide is 0.1 mass % or more and 10 mass % or less.

[5] The positive electrode for a lithium ion battery according to any one of [1] to [4], in which the lithium nickel composite oxide is represented by a chemical formula LiNiₓCo_{y}M_{z}O₂ (x+y+z=1 and 0.6≤x<1.0).

[6] The positive electrode for a lithium ion battery according to any one of [1] to [4], in which the metallic phosphate is VP₂O₇.

[7] A lithium ion battery including the positive electrode for a lithium ion battery according to any one of [1] to [6].

### Advantageous Effects of Invention

According to the present invention, it is possible to improve the durability of lithium ion batteries while realizing an increase in energy density.

### BRIEF DESCRIPTION OF DRAWINGS

FIG. 1 is a perspective view showing the overall configuration of a lithium ion battery according to an embodiment of the present invention.

FIG. 2(a) is a partial cross-sectional view schematically showing the internal configuration of the lithium ion battery of FIG. 1, FIG. 2(b) is an enlarged partial cross-sectional view schematically showing the configuration of a positive electrode for the lithium ion battery in FIG. 2(a), and FIG. 2(c) is a cross-sectional view showing the configuration of a positive electrode active material.

### DESCRIPTION OF EMBODIMENTS

Hereinafter, an embodiment of the present invention will be described in detail with reference to the drawings.

### [Configuration of Positive Electrode for Lithium Ion Battery and Lithium Ion Battery]

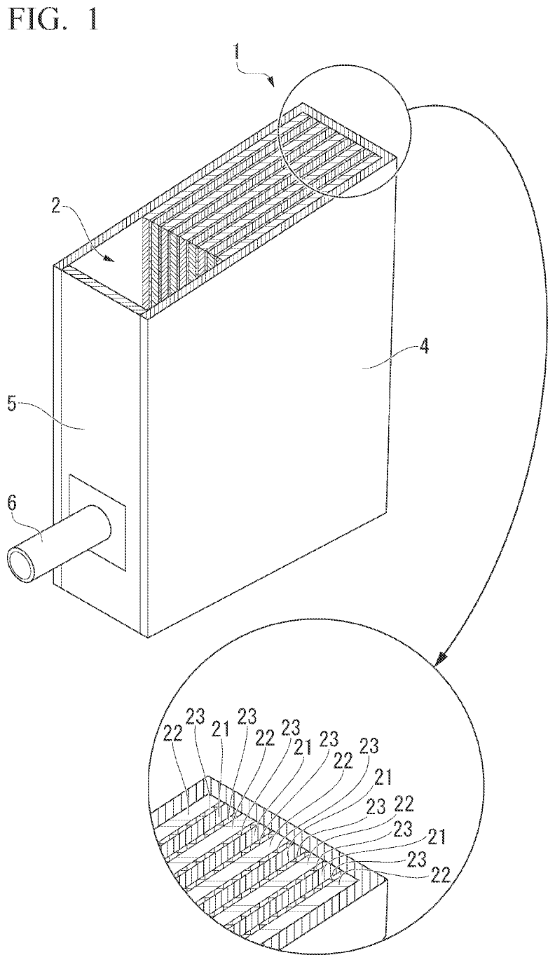

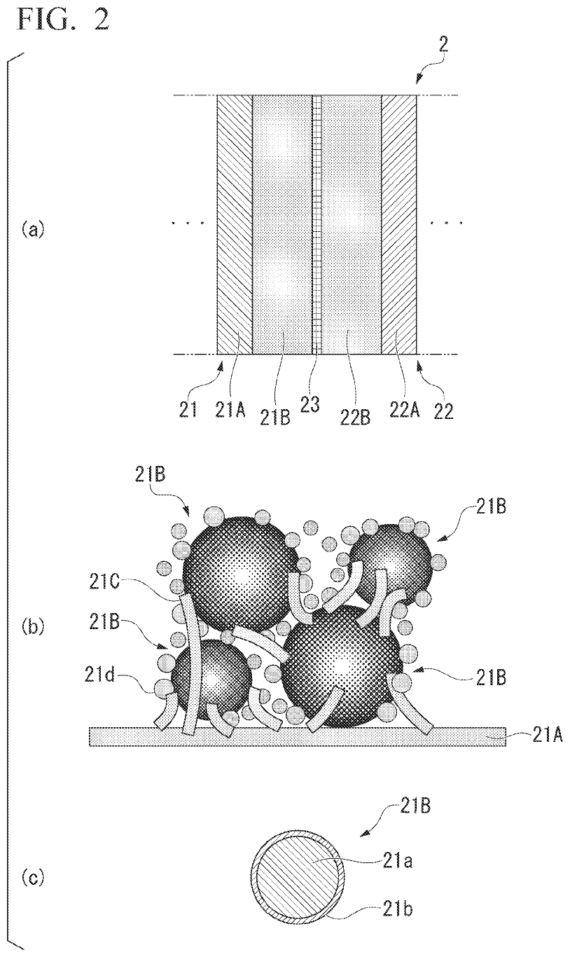

FIG. 1 is a perspective view showing the overall configuration of a lithium ion battery according to the embodiment of the present invention, FIG. 2(a) is a partial cross-sectional view schematically showing the internal configuration of the lithium ion battery of FIG. 1, and FIG. 2(b) is an enlarged partial cross-sectional view schematically showing the configuration of a positive electrode for the lithium ion battery in FIG. 2(a). In some of the drawings to be used in the following description, a characteristic portion is shown in an enlarged manner for convenience in order to facilitate the understanding of the characteristics, and the shapes, dimensional ratios, and the like of individual configurational elements are not limited to those shown in the drawings.

As shown in FIG. 1, a lithium ion battery 1 includes a laminate 2 including electrodes, an exterior body 4 that stores the laminate, and a lid body 5 that seals the exterior body 4. The lithium ion battery 1 is, for example, a square lithium ion secondary battery. The exterior body 4 is made of, for example, a metal chassis.

As shown in FIG. 2(a) and FIG. 2(b), the laminate 2 includes positive electrodes for the lithium ion battery 21 (hereinafter, also simply referred to as the positive electrodes), negative electrodes for the lithium ion battery 22 (hereinafter, also simply referred to as the negative electrodes), and separators 23 each interposed between the positive electrode 21 and the negative electrode 22. The positive electrodes 21, the negative electrodes 22, and the separators 23 are impregnated with an electrolytic solution. Positive electrode current collectors 21A are connected to, for example, a positive electrode current collection portion, not shown, and negative electrode current collectors 22A are connected to a negative electrode current collection portion, not shown.

The positive electrode 21 has the positive electrode current collector 21A and a positive electrode mixture layer 21B that is formed on the positive electrode current collector 21A and contains a positive electrode active material.

The positive electrode current collector 21A is, for example, a sheet-like body or film-like body formed of a conductive material. As the conductive material, it is possible to use, for example, metals such as aluminum (Al) or nickel (Ni). In a case where the conductive material is aluminum (Al), it is possible to use an Al—Fe-based alloy such as JIS A8021 or pure aluminum such as JIS A1085. The thickness of the positive electrode current collector 21A is, for example, 8 μm or more and 15 μm or less.

As shown in FIG. 2(c), the positive electrode mixture layer 21B contains a lithium nickel composite oxide 21a and a metallic phosphate 21b that coats the lithium nickel composite oxide 21a. In addition, the positive electrode mixture layer 21B preferably includes a binder 21c and a conductive aid 21d.

The lithium nickel composite oxide 21a is represented by a chemical formula LiNiₓCo_{y}M_{z}O₂ (in the formula, M is one or more elements selected from the group consisting of Mn, Al, Mg and W, x+y+z=1 and 0.6≤x<1.0). The nickel fraction in the lithium nickel composite oxide 21a is increased as described above, whereby it is possible to realize an increase in energy density. In addition, the lithium nickel composite oxide 21a is preferably represented by a chemical formula LiNiₓCo_{y}M_{z}O₂ (x+y+z=1 and 0.6≤x<1.0).

Here, it is well known that, regardless of the concentration of Ni, the crystal structure in the vicinity of the surface of the positive electrode active material alters in the contact area between the positive electrode mixture layer and the electrolytic solution and the intercalation and deintercalation reaction of lithium is hindered. Therefore, the surface of the positive electrode active material is coated with a specific metallic phosphate described below, which is a stable material, whereby it is possible to effectively prevent direct contact between the positive electrode active material and the electrolytic solution. Therefore, for example, even when the lithium nickel composite oxide is any material from NCM811, NCM622 and NCM523, which are lithium nickel cobalt composite oxides (ternary active materials), it becomes possible to prevent direct contact between the composite oxide and the electrolytic solution by using the above-described specific metallic phosphate.

In addition, as the lithium nickel composite oxide 21a, it is possible to use, for example, a compound represented by the above-described chemical formula in which 0.6≤x≤0.95, 0≤y≤0.2 and 0≤z≤0.4 are satisfied.

The lithium nickel composite oxide 21a has, for example, a particle shape. The lithium nickel composite oxide 21a may be primary particles or may be secondary particles which are aggregates of primary particles.

The metallic phosphate 21b is one or more materials selected from the group consisting of VPO₄, VP₂O₇ and VPO₄F and preferably VPO₄F from the viewpoint of further improving durability. In addition, the metallic phosphate 21b does not necessarily need to coat the entire surface of the lithium nickel composite oxide 21a. For example, in a case where the lithium nickel composite oxide 21a has a particle shape, the metallic phosphate 21b preferably coats the surfaces of the particles of the lithium nickel composite oxide 21a. In the example shown in FIG. 2(c), the metallic phosphate 21b coats the entire surface of the lithium nickel composite oxide 21a, but does not necessarily need to coat the entire surface of the lithium nickel composite oxide 21a. The metallic phosphate 21b needs to cover at least a part of the surface of the lithium nickel composite oxide 21a.

In addition, the mass ratio of the metallic phosphate 21b to the lithium nickel composite oxide 21a is 0.01 mass % or more and 20 mass % or less. Therefore, the nickel fraction in the lithium nickel composite oxide 21a is high, and an increase in the energy density of the lithium ion battery is realized by the high nickel fraction. In addition, even in a case where the lithium nickel composite oxide 21a is coated with the metallic phosphate 21b having a mass ratio in the above-described range that is lower than in the related art, during charge and discharge cycles, it is possible to sufficiently suppress oxygen desorption from the surface of the lithium nickel composite oxide 21a, and it becomes difficult for inactive nickel oxide (NiO) to be generated on the surface of the lithium nickel composite oxide 21a, whereby the durability of the lithium ion battery improves.

When the mass ratio of the metallic phosphate 21b to the lithium nickel composite oxide 21a is less than 0.01 mass %, it is not possible to suppress oxygen desorption from the surface of the lithium nickel composite oxide 21a, a crystal strain is generated due to the Jahn-Teller effect (stabilization of the energy state), inactive nickel oxide is generated on the surface of the lithium nickel composite oxide 21a, and the crystal structure in the vicinity of the surface of the positive electrode active material is likely to turn into a spinel structure. On the other hand, when the mass ratio exceeds 20 mass %, since the discharge capacity of lithium vanadium phosphate becomes smaller than the discharge capacity of the lithium nickel composite oxide, the discharge capacity of the entire positive electrode active material decreases, and the energy density of the lithium ion battery decreases. In addition, resistance is increased due to the coating substance, and the output density of the lithium ion battery decreases.

The mass ratio of the metallic phosphate 21b to the lithium nickel composite oxide 21a is preferably 0.1 mass % or more and 10 mass % or less. In such a case, it is possible to further improve the durability of the lithium ion battery while realizing an increase in the energy density.

In addition, in the chemical formula LiNiₓCo_{y}M_{z}O₂ of the lithium nickel composite oxide 21a, 0<y≤0.2 is preferably satisfied. Unlike a nickel ion (Ni³⁺), in a cobalt ion (Co³⁺), since the Jahn-Teller effect does not accompany the generation of a crystal strain, it is possible to suppress the generation of inactive nickel oxide on the surface of the lithium nickel composite oxide 21a due to an increase in the number of cobalt ions (Co³⁺). Therefore, when the fraction of cobalt (Co) in the lithium nickel composite oxide 21a is set to the above-described range, oxygen desorption is further suppressed, and the lamellar structure of the positive electrode active material can be further stabilized. When 0.2<y is satisfied in the chemical formula LiNiₓCo_{y}M_{z}O₂, the discharge capacity of the lithium nickel composite oxide decreases.

As the binder 21c, it is possible to use, for example, polyvinylidene fluoride (PVDF). In addition, as the conductive aid 21d, it is possible to use, for example, a carbon material. As the carbon material, it is possible to use one or more selected from the group consisting of acetylene black, carbon nanotubes, graphene and graphite particles. As the carbon nanotubes, it is possible to use, for example, VGCFs synthesized by chemical vapor deposition (CVD).

Regarding the blending fractions in the mixture in the positive electrode mixture layer 21B, it is possible to blend the positive electrode active material, the conductive acid and the binder at ratios of, for example, 90 to 95:3 to 5:2 to 5.

The negative electrode 22 has the negative electrode current collector 22A and a negative electrode mixture layer 22B that is formed on the negative electrode current collector 22A and contains a negative electrode active material. The negative electrode mixture layer 22B may contain a binder, a conductive aid, a viscosity improver or the like, which is not shown.

Similar to the positive electrode current collector 21A, the negative electrode current collector 22A is, for example, a sheet-like body or film-like body formed of a conductive material. As the conductive material, it is possible to use, for example, metals such as copper (Cu) or nickel (Ni). In a case where the conductive material is copper, it is possible to use, for example, tough pitch copper such as JIS C1100. The thickness of the negative electrode current collector 22A is, for example, 5 μm or more and 10 μm or less.

The negative electrode active material is not particularly limited, and it is possible to contain, for example, one or a plurality of negative electrode active materials selected from the group consisting of natural graphite, artificial graphite, hard carbon, activated carbon, silicon (Si), silicon oxide (SiOx), tin (Sn) and tin oxide (SnOx).

As the binder in the negative electrode mixture layer 22B, it is possible to use, for example, one or more selected from the group consisting of polyvinylidene fluoride (PVDF), styrene butadiene rubber (SBR) and carboxymethyl cellulose (CMC). In addition, as the conductive aid in the negative electrode mixture layer 22B, it is possible to use, for example, any one or both of acetylene black and carbon nanotubes. As the carbon nanotubes, it is possible to use, for example, VGCFs synthesized by chemical vapor deposition (CVD).

Regarding the blending fractions in the mixture in the negative electrode mixture layer 22B, it is possible to blend the negative electrode active material, the conductive acid, the binder and the viscosity improver in fractions of, for example, 96 to 98:0 to 1:1 to 2:0.5 to 1.

The positive electrode current collection portion electrically connects the plurality of positive electrode current collectors 21A and a positive electrode terminal 6. The positive electrode current collection portion is made of, for example, aluminum (Al) or an aluminum alloy.

The negative electrode current collection portion electrically connects the plurality of negative electrode current collectors 22A and a negative electrode terminal, not shown. The negative electrode current collection portion is made of, for example, copper (Cu) or a copper alloy.

The lithium ion battery 1 has a square form, but the form of the lithium ion battery 1 is not limited thereto and may be a laminate cell form or a cylindrical form. In addition, the exterior body 4 of the lithium ion battery 1 is, for example, a metal chassis, but is not limited thereto, and the exterior body may be a laminate film.

In a case where the exterior body of the lithium ion battery 1 is a laminate film, the laminate film may have a base material, a protective layer and an adhesive layer. The base material is made of, for example, aluminum (Al) or stainless steel such as SUS. The protective layer is made of, for example, one or more selected from the group consisting of polyethylene terephthalate (PET), polyethersulfone (PES) and nylon. The adhesive layer is made of, for example, a polyolefin resin. As the polyolefin resin, it is possible to use, for example, any of maleic anhydride-modified polyethylene and polypropylene (PP).

The separator 23 is an insulating thin film and is a porous body formed of a material, for example, a polyethylene resin, a polypropylene resin or an aramid resin. In addition, the separator 23 may have a porous body and a coating layer formed on the surface of the porous body. As the coating layer, it is possible to use, for example, ceramic made of silicon oxide (SiOx) or aluminum oxide (Al₂O₃), an aramid resin or the like.

The electrolytic solution may contain, for example, a solvent, a lithium salt, and an additive.

As the solvent, it is possible to use one or more selected from the group consisting of ethylene carbonate (EC), propylene carbonate (PC), dimethyl carbonate (DMC), ethyl methyl carbonate (EMC), diethyl carbonate (DEC) and γ-butyrolactone (γBL).

As the lithium salt, it is possible to use one or more selected from the group consisting of LiPF₆, lithium bis(fluorosulfonyl)imide (LiFSl), lithium bis(trifluoromethanesulfonyl)imide (LiTFSl), lithium bis(oxalato)borate (LiBOB), lithium difluorophosphate (LiDFP) and lithium difluoro(oxalato)borate (LiDFOB).

As the additive, it is possible to use one or more selected from the group consisting of vinyl carbonate (VC), fluoroethylene carbonate (FEC), propane sultone (PS) and propene sultone (PRS).

Hitherto, the embodiment of the present invention has been described in detail, but the present invention is not limited to the above-described embodiment and can be transformed or modified in a variety of manners within the scope of the gist of the present invention described in the claims.

### EXAMPLES

Hereinafter, examples of the present invention will be described. However, the present invention is not limited only to the following examples.

### Example 1-1

A predetermined amount of tetraacetic acid vanadium was dissolved in distilled water and stirred for 30 minutes, thereby obtaining a solution A. In addition, the same number of moles of NH₄H₂PO₄ was dissolved in the tetraacetic acid vanadium, thereby obtaining a solution B1. The solution B1 was added dropwise to a solution C obtained by dispersing a nickel composite oxide (LiNi_{0.8}Co_{0.1}Mn_{0.1}O₂) in the solution A and stirred for three hours, thereby obtaining a solution DL. The solution D1 was dried in an oil bath (60° C.) and then thermally treated at 300° C. for five hours, thereby obtaining a positive electrode active material in which the surface of a lithium nickel composite oxide was coated with VPO₄. The mass ratio of the metallic phosphate to the lithium nickel composite oxide in the obtained positive electrode active material is shown in Table 1.

Next, the obtained positive electrode active material (91 mass %), a carbon material that was a conductive aid (3 mass %) and a PVDF binder that was a binding agent (3 mass %) were mixed to adjust a positive electrode mixture slurry, and the positive electrode mixture slurry was applied onto a 15 μm-thick aluminum foil. The amount of the positive electrode mixture slurry applied was set to 21.2 mg/cm². After that, the positive electrode mixture slurry was dried and rolled, thereby obtaining a positive electrode. The dimensions of the positive electrode were 40 mm×40 mm.

In addition, natural graphite (97 mass %), a carbon material that was a conductive aid (1 mass %), SBR that was a binder (1 mass %) and CMC that was a viscosity improver (1 mass %) were mixed to adjust a negative electrode mixture slurry, and the negative electrode mixture slurry was applied onto a rolled copper foil having a film thickness of 8 μm. The amount of the negative electrode mixture slurry applied was set to 12.5 mg/cm². After that, the negative electrode mixture slurry was dried and rolled, thereby obtaining a negative electrode. The dimensions of the negative electrode were 44 mm×44 mm.

Next, the positive electrode, the negative electrode, which were obtained above, and a polyolefin porous separator were prepared, the positive electrode, the porous separator, and the negative electrode were laminated in this order and wound, thereby forming a laminate. Next, the laminate was stored in an exterior body, and a positive electrode current collection portion and a negative electrode current collection portion were connected to a positive electrode terminal and a negative electrode terminal, respectively. After that, 1.2 M LiPF₆ was mixed into EC (30 wt %), EMC (40 wt %) and DMC (30 wt %) to adjust an electrolytic solution, the electrolytic solution was loaded into the exterior body, and the exterior body was sealed with a lid body, thereby obtaining a lithium ion battery.

### Example 1-2

A positive electrode and a lithium ion battery were obtained in the same manner as in Example 1-1 except that the mass ratio of the metallic phosphate to the lithium nickel composite oxide in the positive electrode active material was changed.

### Example 2-1

A predetermined amount of tetraacetic acid vanadium was dissolved in distilled water and stirred for 30 minutes, thereby obtaining a solution A. In addition, the same number of moles of NH₄H₂P₂O₇ was dissolved in the tetraacetic acid vanadium, thereby obtaining a solution B2. The solution B2 was added dropwise to a solution C obtained by dispersing a nickel composite oxide (LiNi_{0.8}Co_{0.1}Mn_{0.1}0₂) in the solution A and stirred for three hours, thereby obtaining a solution D2. The solution D2 was dried in an oil bath (60° C.) and then thermally treated at 300° C. for five hours, thereby obtaining a positive electrode active material in which the surface of a nickel composite oxide positive electrode was coated with VP₂O₇. After that, a positive electrode and a lithium ion battery were obtained in the same manner as in Example 1-1.

### Example 2-2

A positive electrode and a lithium ion battery were obtained in the same manner as in Example 2-1 except that the mass ratio of the metallic phosphate to the lithium nickel composite oxide in the positive electrode active material was changed.

### Example 3-1

A predetermined amount of tetraacetic acid vanadium was dissolved in distilled water and stirred for 30 minutes, thereby obtaining a solution A. In addition, the same number of moles of NH₄H₂PO₄ was dissolved in the tetraacetic acid vanadium, and furthermore, PTFE was dispersed, thereby obtaining a solution B3. The solution B3 was added dropwise to a solution C obtained by dispersing a nickel composite oxide (LiNi_{0.8}Co_{0.1}Mn_{0.1}O₂) in the solution A and stirred for three hours, thereby obtaining a solution D3. The solution D3 was dried in an oil bath (60° C.) and then thermally treated at 450° C. for five hours, thereby obtaining a positive electrode active material in which the surface of a nickel composite oxide was coated with VPO₄F. After that, a positive electrode and a lithium ion battery were obtained in the same manner as in Example 1-1.

### Example 3-2

A positive electrode and a lithium ion battery were obtained in the same manner as in Example 3-1 except that the mass ratio of the metallic phosphate to the lithium nickel composite oxide in the positive electrode active material was changed.

### Comparative Example 1

A positive electrode and a lithium ion battery were obtained in the same manner as in Example 1-1 except that the surface of the lithium nickel composite oxide was not coated with the metallic phosphate.

Next, the obtained lithium ion batteries were measured and evaluated by the following methods.

### [Initial Resistance]

At an ambient temperature of 25° C., SOC was adjusted to 50%, and 3C discharging was performed for 10 seconds. The measurement values of the voltage and the current at that time were measured, and a resistance value was calculated from the following expression (1), thereby obtaining the initial resistance.

Initial resistance (R)=(OCV−voltage after 10 seconds)/discharge current (1)

### [Capacity Retention]

At an ambient temperature of 45° C., charging conditions were set to 0.6C and a cutoff voltage of 4.2 V, discharging conditions were set to 1.2C and a cutoff voltage of 2.7 V, and the cycle was performed 600 times. The capacity retention (%) was obtained from the following expression (2).

Capacity retention (%)=(discharge capacity at 600^{th} cycle/discharge capacity at 1^{st} cycle)×100 (2)

### [Resistance Increase Rate]

The initial resistance was represented by R₀, the resistance after a time (t) taken for 600 cycles had elapsed was represented by Rₜ, and the resistance increase rate (%) was obtained from the following expression (3).

Resistance increase rate (%)=Rₜ/R₀×100 (3)

The measurement results are shown in Table 1.

TABLE 1

| | | Example | Example | Example | Example | Example | Example | Comparative |
|---|---|---|---|---|---|---|---|---|
| | | 1-1 | 1-2 | 2-1 | 2-2 | 3-1 | 3-2 | Example 1 |
| Coating | | VPO₄ | VPO₄ | VP₂O₇ | VP₂O₇ | VPO₄F | VPO₄F | None |
| substance | | | | | | | | |
| Amount applied | (mass | 0.5 | 5 | 0.5 | 5 | 0.5 | 5 | 0 |
| | %) | | | | | | | |
| Positive | | 40 mm × 40 mm | | | | | | |
| electrode sizes | | | | | | | | |
| Initial resistance | [Ω] | 1.05 | 1.3 | 1.06 | 1.38 | 1.04 | 1.29 | 1 |
| Capacity | (%) | 82% | 85% | 81% | 84% | 83% | 86% | 73% |
| retention | | | | | | | | |
| Resistance | (%) | 121% | 117% | 128% | 124% | 115% | 123% | 137% |
| increase rate | | | | | | | | |

From the results of Table 1, it was found that, in Example 1-1, when the lithium nickel composite oxide was LiNi_{0.8}Co_{0.1}Mn_{0.1}O₂ (x=0.8) and the mass ratio of VPO₄ to the lithium nickel composite oxide was 0.5 mass %, the initial resistance became 1.05Ω, and an increase in the energy density was realized due to the high nickel fraction. In addition, it was found that the capacity retention was higher than the capacity retention of Comparative Example 1, in addition, the resistance increase rate was lower than the capacity retention of Comparative Example 1, and the durability improved.

It was found that, in Example 1-2, the mass ratio of VPO₄ to the lithium nickel composite oxide was 5.0 mass %, the initial resistance was larger than the initial resistance of Example 1-1, but the capacity retention was higher than the capacity retention of Example 1-1, in addition, the resistance increase rate was lower than the resistance increase rate of Example 1-1, and the durability further improved.

In Example 2-1, it was found that, when the lithium nickel composite oxide was LiNi_{0.8}Co_{0.1}Mn_{0.1}O₂ (x=0.8) and the mass ratio of VP₂O₇ to the lithium nickel composite oxide was 0.5 mass %, the initial resistance became 1.06Ω, and an increase in the energy density was realized due to the high nickel fraction. In addition, it was found that the capacity retention was higher than the capacity retention of Comparative Example 1, in addition, the resistance increase rate was lower than the capacity retention of Comparative Example 1, and the durability improved.

In Example 2-2, it was found that the mass ratio of VP₂O₇ to the lithium nickel composite oxide was 5.0 mass %, the initial resistance was larger than the initial resistance of Example 2-1, but the capacity retention was higher than the capacity retention of Example 2-1, in addition, the resistance increase rate was lower than the resistance increase rate of Example 2-1, and the durability further improved.

In Example 3-1, it was found that, when the lithium nickel composite oxide was LiNi_{0.8}Co_{0.1}Mn_{0.1}O₂ (x=0.8) and the mass ratio of VPO₄F to the lithium nickel composite oxide was 0.5 mass %, the initial resistance became 1.04Ω, and an increase in the energy density was realized due to the high nickel fraction. In addition, it was found that the capacity retention was higher than the capacity retention of Comparative Example 1, in addition, the resistance increase rate was lower than the capacity retention of Comparative Example 1, and the durability improved.

In Example 3-2, it was found that the mass ratio of VPO₄F to the lithium nickel composite oxide was 5.0 mass %, the initial resistance and the resistance increase rate were larger than the initial resistance and the resistance increase rate of Example 3-1, but the capacity retention was higher than the capacity retention of Example 1-1, and the durability improved.

On the other hand, in Comparative Example 1, the lithium nickel composite oxide was LiNi_{0.8}Co_{0.1}Mn_{0.1}O₂ (x=0.8), but the lithium nickel composite oxide was not coated with the metallic phosphate, the capacity retention was low, in addition, the resistance increase rate was high, and the durability was poor.

### INDUSTRIAL APPLICABILITY

The positive electrode for a lithium ion battery of the present invention can be applied to lithium ion batteries such as primary batteries or secondary batteries. In addition, the lithium ion battery of the present invention can be applied to electric vehicles (EV) such as two-wheel vehicles and four-wheel vehicles and is particularly preferable for electric vehicles or hybrid vehicles.

### BRIEF DESCRIPTION OF THE REFERENCE SYMBOLS

1 Lithium ion battery
2 Laminate
4 Exterior body
5 Lid body
6 Positive electrode terminal
21 Positive electrode
21A Positive electrode current collector
21B Positive electrode mixture layer
21a Lithium nickel composite oxide
21b Metallic phosphate
21c Binder
21d Conductive aid
22 Negative electrode
22A Negative electrode current collector
22B Negative electrode mixture layer
23 Separator

What is claim is:

1. A positive electrode for a lithium ion battery comprising:
a positive electrode current collector; and
a positive electrode mixture layer formed on the positive electrode current collector,
wherein the positive electrode mixture layer contains a lithium nickel composite oxide and a metallic phosphate that coats the lithium nickel composite oxide,
the lithium nickel composite oxide is represented by a chemical formula LiNiₓCo_{y}M_{z}O₂ (in the formula, M is one or more elements selected from the group consisting of Mn, Al, Mg and W, x+y+z=1 and 0.6≤x<1.0),
the metallic phosphate is one or more materials selected from the group consisting of VPO₄, VP₂O₇ and VPO₄F, and
a mass ratio of the metallic phosphate to the lithium nickel composite oxide is 0.01 mass % or more and 20 mass % or less.

2. The positive electrode for a lithium ion battery according to claim 1,
wherein, in the chemical formula, 0<y≤0.2 is satisfied.

3. The positive electrode for a lithium ion battery according to claim 1,
wherein the metallic phosphate coats an entire surface of the lithium nickel composite oxide.

4. The positive electrode for a lithium ion battery according to claim 1,
wherein the mass ratio of the metallic phosphate to the lithium nickel composite oxide is 0.1 mass % or more and 10 mass % or less.

5. The positive electrode for a lithium ion battery according to claim 1,
wherein the lithium nickel composite oxide is represented by a chemical formula LiNiₓCo_{y}M_{z}O₂ (x+y+z=1 and 0.6≤x<1.0).

6. The positive electrode for a lithium ion battery according to claim 1,
wherein the metallic phosphate is VP₂O₇.

7. A lithium ion battery comprising:
the positive electrode for a lithium ion battery according to claim 1.
